(19) United States
(12) Patent Application Publication
(10) Pub. No.: US 2021/0129389 A1
(43) Pub. Date: May 6, 2021

(54) SEALING SYSTEM AND MOLDING TOOL

(71) Applicant: FRIMO GROUP GMBH, Lotte (DE)

(72) Inventors: Jürgen Lause, Hasbergen (DE); Hermann Huster, Bad lburg (DE)

(21) Appl. No.: 16/635,844

(22) PCT Filed: Aug. 3, 2018
(86) PCT No.: PCT/EP2018/071153

§ 371 Date: Jan. 31, 2020

(30) Foreign Application Priority Data
Aug. 3, 2017 (DE) 10 2017 213 494.1

(51) Int. Cl. B29C 33/00; B29C 44/34

(52) U.S. Cl. CPC B29C 33/0038; B29C 44/58; B29C 44/351

(57) ABSTRACT

The invention relates to a sealing system for sealing adjacent machine parts, in particular molding tool parts for foaming vehicle parts. The sealing system comprises a sealing device for sealing adjacent machine parts and a light output device which is arranged in such a way that the light output device can illuminate a portion of the sealing device.

### TECHNICAL FIELD

The invention relates to a sealing system for sealing adjacent machine parts, in particular molding tool parts for foaming vehicle parts. In addition, the present invention relates to a molding tool and to a use.

### PRIOR ART

In the field of the automotive supply industry, various components for vehicles are produced using a foaming process, wherein a foam material, in particular a polyurethane foam material, is injected into a mold cavity of a molding tool or is filled into the open cavity. A dimensionally stable support and a surface material have already been placed in the mold cavity. During the course of the foaming process, the dimensionally stable support is connected to the surface material.

Since the foam material is at first a relatively thin fluid when it is introduced into the mold cavity, the aforementioned molding tools comprise one or more sealing devices to prevent the foam material from escaping from the molding tool. These sealing devices are arranged on a molding tool part in such a way that they surround the component to be formed. The sealing device comprises one or more elastic sealing tubes which are connected to one or more connecting bodies.

Moreover, the introduction of the liquid polyurethane triggers a chemical reaction in the closed molding tool, wherein gas is released. If the gas cannot escape, gas bubbles form. These gas bubbles may have a negative effect on the component quality.

In EP 2 907 643 A1 a sealing device is described, wherein an inflatable connecting body is provided in addition to an inflatable tube. Both the sealing tube and the connecting body are placed in respective depressions in the molding tool.

In order to activate such a sealing device, the sealing tubes are supplied with compressed air. As a result, the corresponding sealing tube inflates and thus provides a sealing region for the opposite molding tool half.

Sealing tubes supplied with compressed air have proven to be extremely advantageous in practice. However, when operating such a sealing device or a molding tool comprising such a sealing device it must be ensured that the compressed air can be held in the corresponding sealing tube. In the case of such a sealing tube tears may occur, for example, during the course of the service life thereof, as a consequence of which the sealing effect may be diminished or altogether absent.

If the sealing effect is reduced or diminished, it should be ensured that the defective sealing device is replaced as soon as possible. Despite the fact that the reduced pressure level is an indication of this, it may be that it is disregarded or misinterpreted by the operator. As a consequence, production continues in spite of a defective or not fully functional sealing device.

### The Subject Matter of the Invention

The object of the invention is to further improve quality assurance and avoid defective products.

The subject matter of claim 1 provides a solution to the aforementioned object. Further preferred embodiments are described in the dependent claims. Moreover, the present invention relates to a molding tool comprising a sealing system for sealing two molding tool halves.

The present invention is based on the idea of supporting the operator of a tool, in particular a molding tool, to the effect that he can identify a defective or not fully functional sealing device as soon as possible, so as to be able to take corresponding corrective action. This may mean, for example, that the sealing device is replaced. In this regard, a particular object of the present invention is to indicate a defective sealing device to the operator of the tool, in particular visually. A sealing device in good working order can also be indicated to the operator, in particular visually.

The sealing system according to the invention comprises: a sealing device for sealing adjacent machine parts, in particular molding tool parts; and a light output device which is arranged in such a way that the light output device can illuminate a portion of the sealing device.

The sealing system according to the invention has the advantage that the operator directly identifies from the sealing device itself whether it is operational or whether it may be defective. In this case illuminating means directing a beam of light onto a portion of the sealing device, in particular light of a certain color, such as red or green. Since the operator is able to directly perceive this, in particular before he places a mold skin in a molding tool or carries out a different activity in connection with a tool comprising the sealing system, continued production is prevented. As a result, the reject rate can be significantly reduced since the replacement of a sealing device is carried out considerably earlier on account of the defect being able to be identified immediately.

According to a preferred embodiment, the sealing device comprises an inflatable sealing tube.

In this case “inflatable” means a material property according to which the element in question can be elastically expanded by way of pressure being applied from the inside. In so doing, the circumference of the sealing tube increases.

The sealing tube may for example be produced from silicone. A silicone sealing tube has the advantage that it has less foam adhesion, and therefore it is particularly suitable for sealing a molding tool for foam backing.

Moreover, the sealing device may comprise a connecting body, wherein it is preferred that the connecting body is inflatable. In this way the connecting body can establish a connection between a compressed air supply and a sealing tube. The connecting body may also be produced from silicone and therefore also realize the advantages described above.

According to one embodiment, the light output device is arranged in such a way that the light output device is able to illuminate the connecting body. For instance, the light output device, in plan view on a sealing device attached to a molding tool, may be provided beneath the connecting body.

It is preferred that the sealing device is produced at least in part from a transparent or partly transparent material. Thus, the corresponding portion, for example the connecting body, glows in the color emitted by the light output device.

According to an alternative embodiment, the sealing device is produced from a non-transparent material. In this case the illumination of the sealing device results in a light reflection on one or more surfaces of the sealing device. The light reflected by the sealing device can accordingly be perceived. Also in this case, the relevant portion, for example the connecting body, glows in the color emitted by the light output device.

According to a variant of the invention, the light output device is configured to emit different lighting colors. For example, a green color is emitted to indicate a sealing device in good working order, while a red color is emitted to indicate a defective sealing device. Thus, several functions can be integrated into one sealing system.

The light output device may for example be an LED light, an OLED light or an optical fiber, in particular a polycarbonate optical fiber. In the case of an LED light or an OLED light, it will be an active light-emitting element. An optical fiber, on the other hand, serves to guide light from what may be an external light to an output area of the optical fiber.

It is preferred that the sealing system further comprises: a pressure sensor for detecting the internal pressure of the sealing device, and a control device configured to control the light output device based on the detection result of the pressure sensor. In this way, the quality assurance function can be considerably improved.

According to a further aspect of the invention, a molding tool is provided which can comprise a sealing system as according to one of the embodiments described above.

The molding tool, which is, in particular, a molding tool for forming foam molded parts, comprises: molding tool parts, which can be moved toward one another to form a mold cavity, wherein there are preferably two molding tool parts opposite one another; a sealing device for sealing the molding tool parts; and a light output device which is arranged at least in part in the molding tool part receiving the sealing device in such a way that the light output device is able to illuminate a portion of the sealing device.

It is preferred that the sealing device comprises an inflatable sealing tube, wherein it is preferable for the sealing tube to be placed at least in part in a groove in at least the molding tool part. When it is in a non-inflated state, the sealing tube is inserted into the groove in its entirety or to a large extent, for example. When it is in an inflated state, the sealing tube may extend in part out of the groove.

Furthermore, the sealing device may comprise a connecting body, in particular an inflatable connecting body, which is placed or introduced at least in part into a recess in at least one of the molding tool parts. When it is in a non-inflated state, the connecting body may, for example, be received in the recess in its entirety or to a large extent. When it is in an inflated state, the connecting body may extend in part out of the recess.

The light output device can be configured to emit a plurality of different lighting colors, wherein it is preferred that the light output device is an LED light, an OLED light or an optical fiber, in particular a polycarbonate optical fiber.

Moreover, it is preferred that the molding tool comprises a pressure sensor for detecting the pressure of the sealing device, and that a control device configured to control the light output device based on the detection result of the pressure sensor is also provided. The control device may be a machine main control unit, for example.

In a further embodiment, a use of a light output device for illuminating a sealing device is provided, wherein the sealing device is used to seal adjacent machine parts, in particular molding tool parts.

Within the scope of this use, a light output device and/or a sealing device can be used in accordance with one of the aspects described above.

In this case it is particularly preferable for the sealing device to comprise an inflatable sealing tube and/or a connecting body, in particular an inflatable connecting body, which is/are produced from a transparent or partly transparent material, for example a silicone material.

A method in which, for example, a sealing system as according to one of the aforementioned aspects or a molding tool as according to one of the aforementioned aspects is used can comprise the following steps:
applying pressure to a sealing device, in particular an inflatable sealing device,
detecting the pressure of the sealing device,
controlling a light output device illuminating a portion of the sealing device, in the event that the detected pressure falls short of a certain pressure level.

It is preferred that when controlling the light output device a change in the color emitted by the light output device is required.

### BRIEF DESCRIPTION OF THE DRAWINGS

With the help of the drawings and the description set out below, the invention will be explained in more detail using an example.

FIG. 1 shows a sealing system according to one embodiment of the present invention using an example.

FIG. 2 shows a perspective detail view in region A of FIG. 1, wherein the sealing device has been omitted.

FIG. 3 shows a sectional view from B-B of FIG. 1.

### DETAILED DESCRIPTION OF THE PREFERRED EMBODIMENT

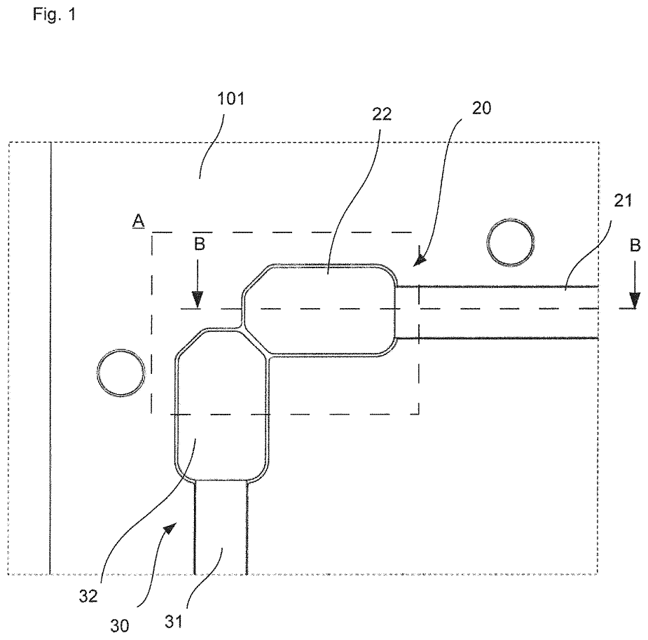

On the basis of the device shown in FIG. 1, a sealing system according to the present invention will be described with the help of an example. Further modifications cited in this context of certain individual features can each individually be combined in order to form further embodiments. Moreover, certain individual features of the described embodiments and modifications thereof can each individually be integrated into the claims in order to form further embodiments of the invention.

FIG. 1 shows a plan view of a molding tool half 101 of a molding tool used for foaming vehicle parts. The present embodiment is not restricted to the automotive sector, however. Components for the aviation sector, for trains, for boats etc. can also be produced using such a molding tool.

The sealing system in FIG. 1 comprises a first sealing device 20, which comprises an inflatable sealing tube 21 and a connecting body 22. In addition, the sealing system comprises a second sealing device 30, which comprises an inflatable sealing tube 31 and a connecting body 32. In the embodiment example according to FIG. 1, the connecting bodies 22, 32 of the first and second sealing devices 20 are arranged so as to be adjacent to one another.

The first and second sealing devices 20, 30 are each received in a depression of the molding tool part 101. In particular, the sealing tube 21 of the first sealing device 20 is received in a groove in the molding tool part 101, and the connecting body 22 of the first sealing device 20 is received in a recess in the molding tool part 101. The same is true for the second sealing device 30.

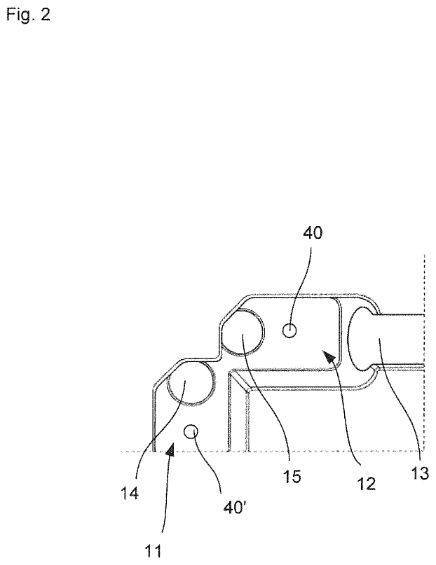

FIG. 2 shows a detail view (of region A) of the molding tool part 101 shown in FIG. 1, wherein in FIG. 2 the sealing devices 20, 30 have been omitted.

Thus, FIG. 2 shows a recess 11 and a recess 12, wherein a groove 13 extends from the recess 12. Possible receiving elements for a connecting body are shown by the recesses 11, 12. The groove 13 illustrates a possible receiving element for an inflatable sealing tube which is connected to a connecting body.

The recess 11 is designed to receive the connecting body 22, and the recess 12 is designed to receive the connecting body 32, while the sealing tube 21 is guided into the groove 13.

In this embodiment example, the connecting bodies 22, 32 are dimensioned so as to be substantially the same. In other embodiment examples, the connecting bodies on a molding tool part may differ.

Bores 14, 15 are provided in each of the recesses 11, 12, through which compressed air can be introduced into the respective connecting bodies 22, 32.

Furthermore, when viewed in plan view an opening is located on the base side of each of the recesses 11, 12, into each of which a light output device 40, 40′ is inserted. If there is a connecting body in the respective recesses 11, 12, the light output device 40, 40′ will be concealed by the connecting body.

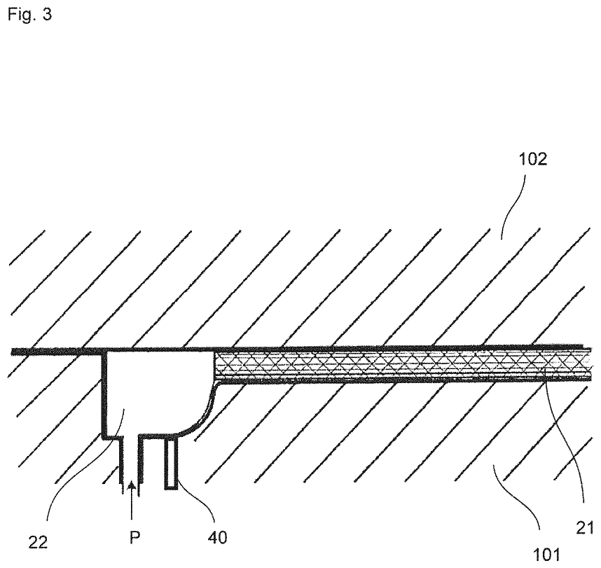

FIG. 3 is a schematic sectional view along the line B-B in FIG. 1. It is clear that the sealing tube 21 is placed in a groove in the molding tool part 101 and the connecting body 22 is placed in a recess in the molding tool part 101. The compressed air supply (cf. reference P in FIG. 3) to the connecting body 22 is also schematically shown therein.

During operation, the sealing tube 21 is supplied with compressed air via the connecting body 22. In this way, a seal is created between the molding tool parts 101, 102.

The light output devices 40, 40′ are also arranged in the molding tool part 101 in which the first and second sealing devices 20, 30 are received. The light output device 40 is configured in such a way that it can illuminate the connecting body 22 of the first sealing device 20. A light output device 40′ is also provided on the connecting body 32 of the second sealing device 30.

In the following, the operation of just the light output device 40 will be described. However, the light output device 40′ for the second sealing device 30 has the same or similar functions.

During normal operation, the connecting body 22 is illuminated with a green light emitted from the light output device 40. Since the connecting body 22 is produced from a transparent or partly transparent material, for example a silicone material, the connecting body 22 glows green.

Moreover, a pressure sensor (not shown) with which the pressure conditions of the first sealing device 20 can be detected is arranged in the molding tool part 101 or on the compressed air supply. A corresponding pressure sensor is also provided for the second sealing device 30, and/or a pressure sensor can check different sealing circuits one after the other in a staggered manner.

If the pressure sensor detects that the pressure level achieved at the first sealing device 20 is not sufficient despite pressure having been applied, a control device (not shown) will control the light output device 40 in such a way that the color it emits changes. The connecting body will be illuminated in red, for example. In this case the connecting body will therefore glow red.

In this way, the operator can immediately see when the molding tool is open whether or not the sealing device is in a condition in which a certain pressure level can be achieved. If this pressure level is not achieved, the sealing device is defective.

A defect may occur if, for example, the sealing tube 21 or the connecting body 22 becomes brittle or if the connecting area between the connecting body and the sealing tube is leaky, and/or if the sealing effect is diminished as a result of material fatigue or external damage.

When the molding tool is open, the operator can therefore immediately see if a certain sealing device is defective and on the basis of having been shown the sealing device is defective the operator can replace it. During the replacement, the light output device remains in the molding tool part.

In this embodiment, the light output device 40 is an LED light. LED lights have proven to be compact and at the same time extremely robust, and therefore they are particularly suitable for use in a molding tool for foam-backing components.

Furthermore, color changes can be achieved with an LED light, such that the LED light changes in the present embodiment example from a green color to a red color when a defect is identified in the sealing device assigned thereto.

Thus, with the visualization of a defective sealing device as shown in this embodiment example a defect can be directly attributed to a certain sealing device. Moreover, the operator knows when a green color light is shown for all of the sealing devices that they are all working properly.

Thus, not only can the operator identify a defect; he can also determine in a targeted manner which sealing device is to be replaced in the event of such a defect. This is particularly advantageous when a corresponding molding tool has a plurality of sealing devices, as is the case with molding tools used for foam-backing components.

Although an inflatable connecting body has been described within the scope of the present embodiment, it is clear that the present invention can also be used in the case of a sealing device having a rigid connecting body.

According to a further modification, the connecting body and the sealing tube are formed as one piece.

1. A sealing system comprising:
a sealing device configured to seal adjacent machine parts; and
a light output device which is arranged to illuminate a portion of the sealing device.

2. The sealing system according to claim 1, wherein the sealing device includes an inflatable sealing tube.

3. The sealing system according to claim 1, wherein the sealing device includes a connecting body.

4. The sealing system according to claim 3, wherein the light output device is arranged to illuminate the connecting body.

5. The sealing system according to claim 1, wherein the sealing device is produced at least in part from a transparent or partly transparent material.

6. The sealing system according to claim 1, wherein the light output device is configured to emit different lighting colors.

7. The sealing system according to claim 1, wherein the light output device is an LED light, an OLED light or an optical fiber.

8. The sealing system according to claim 1, further comprising:
a pressure sensor configured to detect the pressure of the sealing device; and
a control device configured to control the light output device based on the detection result of the pressure sensor.

9. A molding tool comprising:
a plurality of molding tool parts configured to be moved toward one another to form a mold cavity;
a sealing device configured to seal the molding tool parts; and
a light output device arranged at least in part in one of the molding tool parts receiving the sealing device in such a way that the light output device illuminates a portion of the sealing device.

10. The molding tool according to claim 9, wherein the sealing device includes an inflatable sealing tube.

11. The molding tool according to claim 9, wherein the sealing device includes a connecting body placed at least in part in a recess in at least one of the molding tool parts.

12. The molding tool according to claim 11, wherein the one of the molding tool parts has an opening extending from the recess, wherein the light output device is received in the opening.

13. The molding tool according to claim 9, wherein the light output device is configured to emit a plurality of different lighting colors.

14. The molding tool according to claim 9, further comprising:
a pressure sensor configured to detect internal pressure of the sealing device; and
a control device configured to control the light output device based on the detection result of the pressure sensor.

15. Use of a light output device for illuminating a sealing device, wherein the sealing device is used for sealing adjacent machine parts including molding tool parts.

16. The sealing system according to claim 1, wherein the adjacent machine parts include molding tool parts.

17. The sealing system according to claim 3, wherein the connecting body is inflatable.

18. The sealing system according to claim 7, wherein the optical fiber is a polycarbonate optical fiber.

19. The molding tool according to claim 10, wherein the sealing tube is placed at least in part in a groove in at least one of the molding tool parts.

20. The molding tool according to claim 13, wherein the light output device is an LED light, an OLED light or a polycarbonate optical fiber.
